(19) United States
(12) Patent Application Publication
(10) Pub. No.: US 2017/0032388 A1
(43) Pub. Date: Feb. 2, 2017

(54) SYSTEM AND METHOD FOR EVENT-BASED RESEARCH AND AUDIENCE PROFILING FOR TARGETED MARKETING

(71) Applicant: IAN FOLEY, SAN FRANCISCO, CA (US)

(72) Inventor: IAN FOLEY, SAN FRANCISCO, CA (US)

(21) Appl. No.: 15/222,535

(22) Filed: Jul. 28, 2016

Related U.S. Application Data
(60) Provisional application No. 62/197,972, filed on Jul. 28, 2015.

(51) Int. Cl. G06Q 30/02

(52) U.S. Cl. CPC G06Q 30/0201; G06Q 30/0269

(57) ABSTRACT

A method for matching a business with clients comprising: defining predetermined trends/signals to monitor on third party websites for a predetermined industry; monitoring the third party websites for the predetermined trends/signals; and modeling off loan conversion data to provide a feedback loop to find companies with characteristics with the predetermined trends/signals.

### TECHNICAL FIELD

The present application generally relates to targeted marketing, and, more particularly, to a system and method that uses event-based consumer polling and a relevancy algorithm to create an audience profile of the most relevant users in order to successfully target consumers, benchmark event performance and enable the data to be exported to enterprise knowledge systems.

### BACKGROUND

Advertisers, including proxies, agents, or other entities acting on behalf of or in the interest of advertisers, are constantly competing for the attention of their respective markets. In the past, traditional advertisers relied on past performance purchase or path to purchase data to target audiences. However, past performance data has not been an effective guide to future behavior because audiences may no longer be interested in a particular product or service. Therefore, marketers have turned to third-party audience targeting companies to help them reach new customers. These audience targeting companies gather user data from publishers or other sources of data where consumers have input their user information (e.g. demographic details). Marketers use this targeting data with the hope that a subset of the users within the profile will be relevant to the marketer's brand. However, users often provide inaccurate data and the data profile sets are too broad, which results in low audience relevancy when marketers run advertising campaigns. This results in wasted advertising dollars. Further, while demographic metrics have also been used as a basis for targeted advertisement by allowing advertisers to provide targeted advertisements to individuals based on their age and other characteristics of the user, it does not allow advertisers to obtain insight on whether a potential purchaser is in-market to buy a product or service at the time of a marketing event.

Presently, advertisers engage in digital marketing events to attract consumers to learn more or buy their products or services. Events are defined as a standalone digital marketing campaign (for example branded content video) or a digital extension of a physical event (for example live streaming of a sports event). One of the challenges is that advertisers often distribute the event content through third party tools (for example YouTube or Facebook) which do not give them sufficient insight or ownership of the audience data. Audience data from event content placed on these platforms is owned by the third party platform, requiring advertisers to go back to the third party to retarget or remarket their audience. Also, data on consumer insights is restricted to whatever data the third party platform makes available, which has limited value beyond understanding consumer engagement.

Presently, advertisers receive post-event analysis from their marketing partners that provide insufficient insight to measure return on investment (ROI) from each event. The measurements are mostly restricted to advertising attentiveness data (e.g. Click-through Rate (CTR) or Video Completion Rate (VCR)) and do not take into account brand lift. Marketers do not include for advertisers brand lift or measurement after each event, only providing it on bespoke large scale events or when the advertiser pays for this type of research study. Therefore, advertisers lack actionable brand insights or consumer behaviors that can then be used for their broader corporate initiatives, including marketing or product development.

Therefore, it would be desirable to provide a system and method that overcome the above problems.

### SUMMARY

In accordance with one embodiment, a method for matching a business with clients is disclosed. The method comprises: defining predetermined trends/signals to monitor on third party websites for a predetermined industry; monitoring the third party websites for the predetermined trends/signals; and modeling off loan conversion data to provide a feedback loop to find companies with characteristics with the predetermined trends/signals.

### BRIEF DESCRIPTION OF THE DRAWINGS

The present application is further detailed with respect to the following drawings. These figures are not intended to limit the scope of the present application but rather illustrate certain attributes thereof.

FIG. 1 is a block diagram of the system of the present invention;

FIG. 1A is a block diagram of the server/computers used in the system of FIG. 1;

FIG. 2 is a more detailed block diagram showing the system of the present invention; and

FIG. 3 is a block diagram showing operation of the system in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present system and method uses predictive statistical techniques to provide detailed insight into and predictions of brand interest, engagement and consumer activity among a large population of consumers by extrapolation from a small, well-chosen sample set. A key component of any such statistical prediction system is a rich set of data in which each sample is associated with the information the system is expected to predict on the broader population, such as brand perception or engagement. Such a data set is difficult to generate for large audience analysis because of the scale required, and because the training set generation must be repeated for each new analysis desired.

In order to overcome this problem, the present system and method uses audience polling to obtain the initial data set. Audience polling provides the best mechanism to capture event-relevant consumers since the data reflects present or tin-market′ consumer needs and advertisers can customize the polling questions to identify the consumers relevant to a specific event. Using the survey data set combined with additional third-party data, the system uses statistical techniques to develop a predictive model for consumer insights and behavior.

The generated model allows the system to generate a customized benchmark study for each advertiser, including both advertising attentiveness and brand measurement data obtained from the audience polling. The benchmark data is used to create an influence measure that is comparable on an index to other events using the same approach. In addition, the predictive model allows the system to extrapolate consumer insights to larger audiences for other events, results in an audience that consistently delivers higher engagement for each event. The system categorizes the data so that it can be exported to the enterprise knowledge systems of advertisers.

While the present system and method has been described as being used for advertisers, it may be used in other industries as well. For example, the present system and method may be used in the financial services market. The present system and method may be used to help loan brokers identify new merchants for a loan as discussed below.

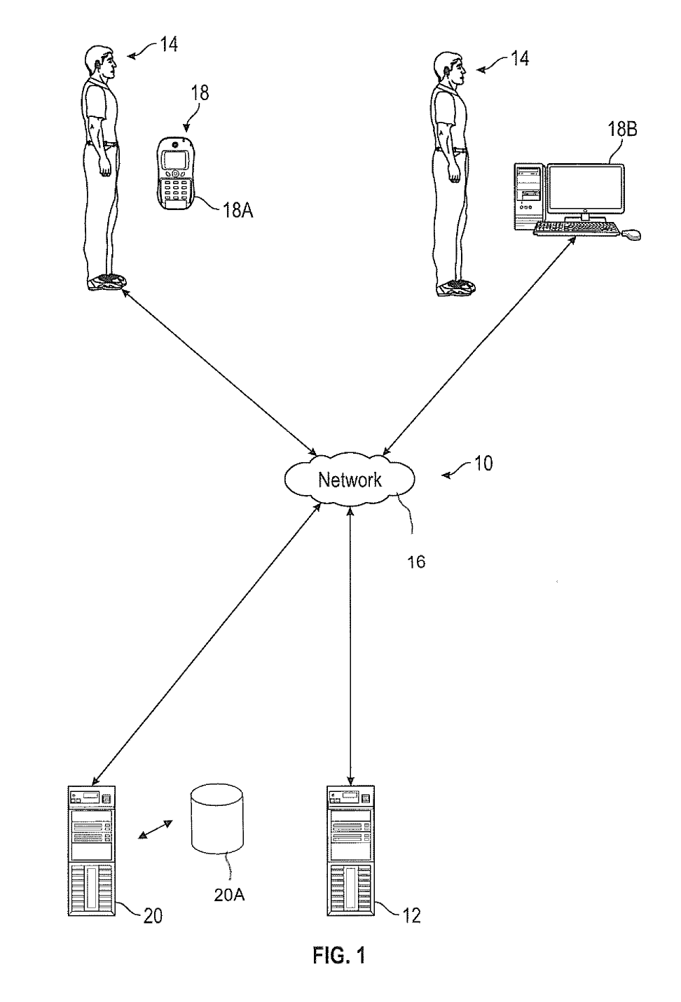

Referring to FIG. 1, a system 10 is shown. The system 10 provides a means for acquiring first-party data through audience polling and using event-based engagement to get higher quality user data and insights. The system may also use second and third party data to obtain additional insight. The system 10 may have a server 12. The server 12 may have a processor. The processor may be implemented in hardware, software or a combination thereof. The processor may store a computer program or other programming instructions associated with a memory to control the operation of the server 12 and to analyze the data received. The data structures and code within the software in which the present application may be implemented, may typically be stored on a non-transitory computer-readable storage. The storage may be any device or medium that may store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. The processor may comprise various computing elements, such as integrated circuits, microcontrollers, microprocessors, programmable logic devices, etc., alone or in combination to perform the operations described herein.

The server 12 may be used for the collection and analysis of polling data as will be discussed below. The polling data collected may be first party data, which is pooled with second and/or third party data to get audience scale. First party data may be loosely defined as information directly collected by the operators of the system 10 about its audience. The “first party” being the operators of the system 10/server 12. In the context of display advertising, first party data is most often cookie-based data, and it can include information gathered from a website(s) hosted on the server 12, data gathered in the user's CRM system, data obtained from consumer polling, subscription data, social data or cross-platform data from mobile web or apps. This data is collected from the operator of the system 10 own audience and customers, and it is generally considered as the most valuable because of its quality.

Second party data may be simply defined as somebody else's first party data. Operators of the system 10 may work out an arrangement with trusted partners who are willing to share their customer/polling data with the operators of the system 10 and vice versa. Second party data may play a large role in audience extension and audience targeting. Third-party data is generated on other platforms and often aggregated from other websites. There are many companies out there that sell third-party data, and it is accessible through many different avenues.

In operation, the server 12 may communicate with one or more individuals 14 via a network 16 to collect first party polling data. The network 16 may include a fixed wire line network, cable and fiber optics, over the air broadcasts, cellular, satellite, local area network (LAN), wide area network (WAN), or global network (e.g., Internet). The individuals 14 may communicate with the server 12 through communication devices 18. The communication devices 18 may be portable electronic communication devices 18A such as smart phones, tablets, laptops, and the like; desktop computers 18B, or other similar communication devices.

Alternatively, or in addition to, the server 12 may access data from a third party server 20. The data accessed may be used to create an audience profile of the most relevant users in order to successfully target consumers, benchmark event performance and enable the data to be exported to enterprise knowledge systems. The server 20 may obtain information which is stored on the server 20 by hosting a website 20A. Individuals 14 may access the website 20A and enter different information which may be stored on the server 20. For example, the individual 14 may enter demographic information as well as answer questions related to the sponsorship and/or banded content. Information entered into the website 20A will be sent to server 12 via the network 16. This information will be stored and analyzed by the server 12. In accordance with one embodiment, the website 20A may be a service type website. The service type website maybe a selling website like Ebay®, Amazon® or similar type of websites; a job posting website like Monster®, Indeed® or similar type of websites; networking websites like LinkedIn® or other topical websites. The server 12 may monitor these types of websites for active trends/signals as will be described below.

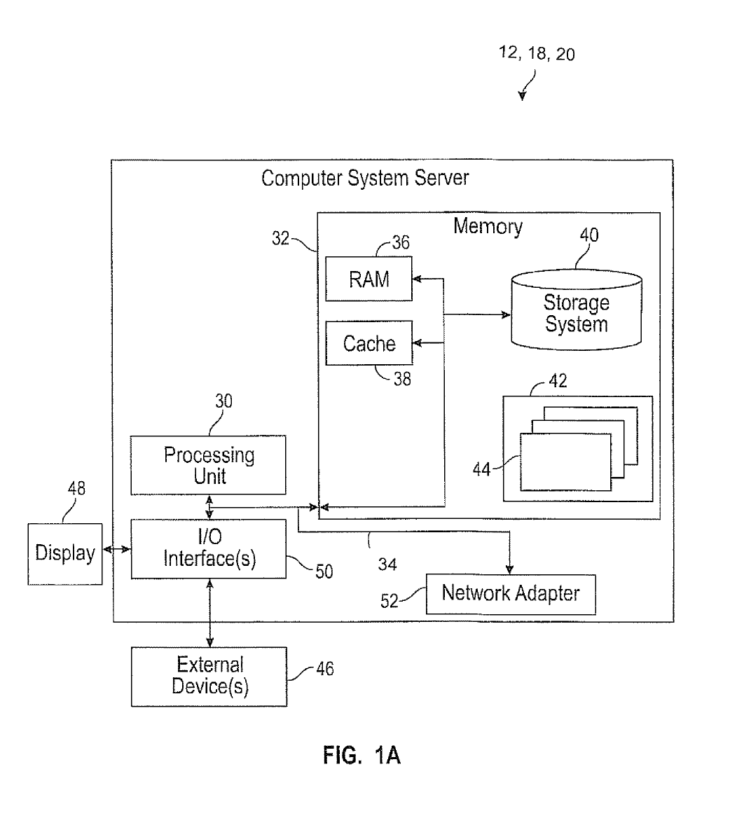

Referring to FIG. 2, the servers 12, 20 and the communication devices 18 may be described in more detail in terms of the machine elements that provide functionality to the systems and methods disclosed herein. The components of the servers 12, 20 and communication device 18 may include, but are not limited to, one or more processors or processing units 30, a system memory 32, and a system bus 34 that couples various system components including the system memory 32 to the processor 30. The servers 12, 20 and communication devices 18 may typically include a variety of computer system readable media. Such media may be chosen from any available media, including non-transitory, volatile and non-volatile media, removable and non-removable media. The system memory 32 could include one or more computing system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may be used to analyze the data received by the server 12.

The server 12 and the communication devices 18 may communicate with one or more external devices 46 such as a keyboard, a pointing device, a display 48 and/or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the servers 12, 20 and the communication devices 18 to communicate directly. Such communication may occur via Input/Output (I/O) interfaces 50. Alternatively, the server 12, 20 and the communication devices 18 may communicate with one or more networks 22 (FIG. 1) such as a local area network (LAN), a general wide area network (WAN), and/or a public network via a network adapter 52. The servers 12, 20 and the communication devices 18 may be coupled to the one or more networks via a wired or wireless connection. As depicted, the network adapter 52 may communicate with the other components of the communication device 18 and/or servers 12, 20 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus,

Referring now to FIGS. 1-4, before, during or after an event, individuals 14 may be asked to answer polling questions related to the advertising event to obtain an initial data set. Operators of the system 10 may work with the advertiser to come up with brand research questions, which may include questions like aided product recall and brand perception. The system 10 uses audience polling to create the initial data set used for a statistical analysis of the advertising event. Users selected by demographic characteristics based on the expected customer profile are asked questions to determine their interests and behavior. The poll results provide information about relationships between audience characteristics and relevant behaviors.

To obtain the most reliable data, the individuals 14 are selected from the pool of available consumers to fit the profile of the advertising event and/or the advertisers target audience. Individuals 14 may enter first party polling data by accessing a website hosted on the server 12 via communication devices 18. For example, an individual 14 may access a website hosted on the server 12 via a communication device 18. Once at the website, the individual may enter demographic information as well as answer questions related to the sponsorship and/or banded content event. This information will be stored and analyzed by the server 12.

Alternatively, or in addition to, an individual 14 may access the pool data through a third party website 20A (hereinafter site 20A). The website 20A may be associated with the operators of the server 20. Once the website 20A is accessed, the individual 14 may enter demographic information as well as answer questions related to the sponsorship and/or banded content. Information entered into the website 20A will be sent to server 12 via the network 16. This information will be stored and analyzed by the server 12.

The polling questions may be divided into a plurality of different subsets. This may enable the system 10 to obtain a more compressive understanding of the individual 14. The system 10 may offer participating individuals 14 a survey completion incentive relevant to event in order to entice the individual to answer all the polling questions.

The polling questions that the individuals 14 answer via the devices 18 may be static and/or dynamic. The polling data can be either static or dynamic, based on the topic. For example, if it is a question that requires careful calibration to get to the right audience, the software may use a question upfront to exclude non-relevant folks. For example, certain questions such as age, sex, etc. may be asked to all individuals. However, other questions may be dynamically based and different questions may be asked based on the answer to the questions. For example, if the individual 14 answers “Yes” to a question related to ownership of a sports utility vehicle (SUV), then additional, more comprehensive questions may be asked as to the individual's opinion of SUVs. However, if the individual 14 answers “NO” to a question related to ownership of an SUV, then a next group of questions unrelated to SUVs would be asked.

The server 12 may be coupled to one or more third party servers 20. The third party servers 20 may have second and third party data related to the advertiser event. The third party servers 20 may collect this information through third party websites, third party apps, and the like. The third party servers 20 may send this collected information to the server 12 via the network 16.

As stated above, the server 12 may access data from a third party server 20. The data accessed may be used to create an audience profile of the most relevant users in order to successfully target consumers, benchmark event performance and enable the data to be exported to enterprise knowledge systems. The server 20 may obtain information which is stored on the server 20 by hosting the website 20A. Individuals 14 may access the website 20A and enter different information which may be stored on the server 20. For example, the individual 14 may enter demographic information as well as answer questions related to the sponsorship and/or banded content. Information entered into the website 20A will be sent to server 12 via the network 16. This information will be stored and analyzed by the server 12. In accordance with one embodiment, the website 20A may be a service type website. The service type websites 20A may be a selling website like Ebay®, Amazon® or similar type of websites; a job posting website like Monster®, Indeed® or similar type of websites; networking websites like LinkedIn® or other topical websites. The server 12 may monitor these types of websites for active trends/signals. These trends/signals may be additional information that not only can help advertisers create more defined audience profiles of the most relevant users in order to successfully target consumers, but may be used by other types of companies/individuals to identify new clientele.

For example, the system 10 may be used in the financial services market. By accessing data from the different servers 20, companies in the financial services market may be able to identify new customers for loans. Traditionally, loan brokers used public data and digital marketing to predict a customer's need based on past performance (e.g. loan history); however, this only opened up 20% of the market. The system 10 may help to identify the other untapped 80% of the market for merchants that might not be aware of loan products.

The server 12 may monitor these types of websites 20A for active trends/signals. For the financial services market the server 12 may monitor active signals that might identify companies in growth or distress modes. For example, the server 12 may identify an online eBay seller that is seeing a doubling in social media reviews or a company's LinkedIn profile showing an increase in software engineers, both of which are a signal of a company in potential growth mode, and therefore a fit for a working capital loan. Likewise, numerous job postings on Monster® or other job searching website may also a signal of a company in potential ‘growth mode, and therefore a fit for a working capital loan.

The server 12 is able to monitor and detect these active trends/signals by constantly crawling the web for predictors and then modeling off loan conversion data to provide a feedback loop to find companies with ‘look-alike’ characteristics. The system 10 also uses an Artificial Intelligence Engine to constantly mine the feedback loop to help test & deploy new types of lead packages and pricing.

It should be noted that the above is given as an example. The server 12 may monitor different websites 20A for other active trends/signals than those disclosed above. The trends/signals being monitored may vary and may depend on the industry.

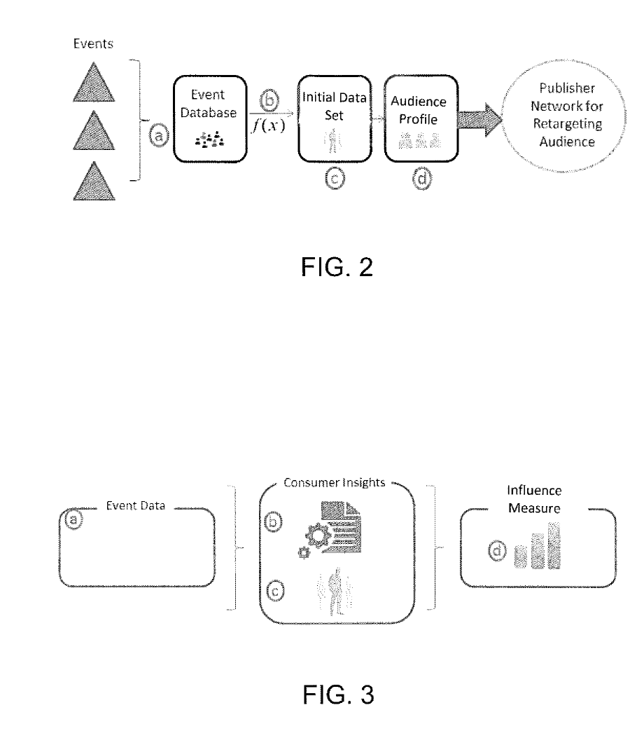

As shown more clearly in FIGS. 2-3, the data collected by the server 12 as well as data transferred from other third party servers 20 related to the advertiser event may be stored in an event database. Software stored within the server 12 may analyze the data collected. The software uses brand receptivity, ad attentiveness, user engagement and event benchmarking data to create unique insights around a particular event.

Software stored within the server 12 may analyze the data collected and uses a relevancy algorithm to create an initial data set of the most relevant users based on the answers provided in the polling data. The algorithm breaks those that responded into a plurality of audience profiles. The audience profiles may be built out by event, event property, brand, industry, etc. The platform uses audience look-alike modeling techniques to scale audience profile and to create consumer insights that provide marketers with actionable results and recommendations to find users with similar attributes to drive large, scalable relevant audiences. The server 12 may then mange ad campaigns on behalf of marketers by offering audience retargeting opportunities to a marketer based on the analyzed date. While after the event, software uses audience and brand research data to provide each advertiser a unique audience profile for follow-on marketing campaigns or for export to the advertiser's enterprise knowledge systems (e.g. Customer Relationship Management, Enterprise Relationship Management). The branded research data may include brand receptivity such as likelihood to recommend, and purchase intent. The branded research data may also include ad attractiveness based on the number of viewers reached, click through rate (CTR) which is a ratio showing how often people who see your advertisement end up clicking it, video completion rate (VCR) which measures the number of post-impression response or view-through from display media impressions viewed during and following an online advertising campaign; as well as other similar data.

The software may include benchmarking the event. By benchmarking the event, the system 10 is able to compare to other events, brands or audiences. The benchmarking approach uses data from previous events and industry data, event performance is analyzed and then weighted to create an influence measure. Events that are analyzed by the system 10 may be placed on an influence score index.

While embodiments of the disclosure have been described in terms of various specific embodiments, those skilled in the art will recognize that the embodiments of the disclosure may be practiced with modifications within the spirit and scope of the claims.

1. A method for matching a business with clients comprising:
defining predetermined trends/signals to monitor on third party websites for a predetermined industry;
monitoring the third party websites for the predetermined trends/signals; and
modeling off loan conversion data to provide a feedback loop to find companies with characteristics with the predetermined trends/signals.

2. The method of claim 1, comprising mining the feedback loop to test and deploy new types of lead packages and pricing for the business.

3. The method of claim 1, wherein defining predetermined trends/signals to monitor comprise monitoring for indicators of companies in growth or distress modes.

4. The method of claim 3, wherein defining predetermined trends/signals to monitor comprise monitoring for indicators of companies in growth or distress modes comprises monitoring third party websites for employment and growth data.

5. The method of claim 1, comprising answering polling questions by a plurality of clients related to an advertising event to obtain an initial data set.

6. The method of claim 5, comprising polling questions may be divided into a plurality of different subsets.

7. The method of claim 5, comprising providing incentives to each of the plurality of clients answering all of polling questions.

8. The method of claim 5, comprising analyzing data provided by answering of the polling questions using a relevancy algorithm to create an initial data set of most relevant clients, wherein the relevancy algorithm divides the clients responding into a plurality of audience profiles.

9. The method of claim 8, comprising:
using audience look-alike modeling techniques to scale the plurality of audience profiles; and
creating consumer insights based on the plurality of audience profiles; and
providing the businesses with actionable results and recommendations to find the clients with similar attributes to the consumer insights.

10. The method of claim 9, comprising offering audience retargeting opportunities to the businesses based on the consumer insights.
